(19) United States
(12) Patent Application Publication
(10) Pub. No.: US 2016/0292353 A1
(43) Pub. Date: Oct. 6, 2016

(54) PREDICTIVE MICROBIAL COMMUNITY MODELING USING A COMBINATION OF PHYLOGENY, GENOTYPING AND MACHINE LEARNING ALGORITHMS

(71) Applicant: ProdermIQ, Inc., San Diego, CA (US)

(72) Inventors: Sasan Amini, Redwood City, CA (US); Dana Hosseini, San Diego, CA (US)

(21) Appl. No.: 15/079,944

(22) Filed: Mar. 24, 2016

Related U.S. Application Data
(60) Provisional application No. 62/141,699, filed on Apr. 1, 2015.

(51) Int. Cl. G06F 19/12; G06F 19/00

(52) U.S. Cl. CPC G06F 19/12; G06F 19/345

(57) ABSTRACT

The present invention relates to providing a platform for predictive modeling of changes in composition of microbial communities upon exposure to changes or perturbations in the environment, more specifically the introduction of antimicrobial compounds, bacteriophages, or other agents that can be used for targeted or personalized therapy or microbiome remodeling. This platform has applications for human and animal health as well as environmental purposes.

### CROSS-REFERENCE TO RELATED APPLICATIONS

This application claims benefit of priority under 35 U.S.C. §119(e) of U.S. Ser. No. 62/141,699, filed Apr. 1, 2015, the entire contents of which is incorporated herein by reference in its entirety.

### BACKGROUND OF THE INVENTION

1. Field of the Invention

The present invention relates to providing a platform for predictive modeling of changes in composition of microbial communities upon exposure to changes or perturbations in the environment, more specifically the introduction of antimicrobial compounds, bacteriophages, or other agents that can be used for targeted or personalized therapy or microbiome remodeling. This platform has applications for human and animal health as well as environmental purposes.

2. Background Information

Emergence of microorganisms' resistance to different classes of antimicrobial agents, or other agents and compounds is turning to a major environmental and healthcare problem. Currently there is considerable pressure on the chemical, pharmaceutical and medical communities to curtail the use of antibiotics especially broad-spectrum antibiotics as a result of the increase in antibiotic resistant strains in our environment. Sensitive and accurate survey of microbial flora or microbiome provides us with an opportunity to understand how different antimicrobial agents may impact that flora on the patient and reduces the chances of opportunistic pathogens dominating the flora. Specifically, by precisely knowing the species of bacteria in a particular environment, knowing every bacteria's predicted response to a particular antimicrobial agent, and knowing strategies that bacterial communities use in response to the agent we can use an analytical engine to predict how the flora will respond and thus optimize the treatment and minimize off-targets effects.

Our proposed solution is more comprehensive than the common notion of antibiotic sensitivity or resistance that is usually defined for homogenous or clonal bacterial populations. Most antibiotic resistance problems happen in the context of complex bacterial communities. The resistant bacteria either emerges from a complex bacterial composition or at some point is likely to be exposed to other types of bacteria. Therefore, antimicrobial resistance should not be studied as an isolated feature, otherwise many community level information, environmental factors, and intra-species and inter-species interactions will be lost.

Historically antibiotic sensitivity assays have been used for predictive modeling of antibiotic resistance/sensitivity. This is the most direct method that requires isolating representative clones from the samples and culturing them on media with and without the antibiotic of interest and identifying which antibiotic works on the isolated clone. There are major shortcomings with this method: it only applies to culturable bacteria. Furthermore it cannot deal with complexity of mix communities with diverse bacterial residence.

FIG. 1 provides an example of the problem inherent in clinical antibiotic treatment today. Two skin microbiome samples (subject 213 and 216) that have been phylogenetically profiled using NGS have been demonstrated here. Both samples are dominated by Propionibacterium acnes. If the goal is to specifically eliminate P. acnes, antibiotics like glycopeptides or lipopeptides are not capable of significantly changing the composition of those microbiome since they work mostly on gram positive bacteria. Among antibiotics that are common for gram negative bacteria, tetracycline is the top choice (these type of insights can be inferred from the generic database, FIG. 2, box III). However, our antibiotic resistance profiling shows that subject number 216 has a significant fraction of tetracycline resistant bacteria and tetracycline is not the best antibiotic for changing the composition of that microbiome.

This invention describes how the combination of phylogeny and genotyping can be used to simultaneously identify all resident bacteria and resistance genes (elements) in a complex bacterial community.

### Summary of the Invention

### DESCRIPTION OF THE DRAWINGS

FIG. 1 is an example of two microbiome samples that have been phylogenetically profiled and also screened for presence of a tetracyclin resistance SNP.

FIG. 2 is a schematic of predictive antibiotic, bacteriophage, or other agents and compounds used for targeted or personalized therapy or microbiome remodeling sensitivity modeling using a combination of phylogeny and genotyping

FIG. 3 is an example of bacteria with known sensitivity and resistance profiles.

FIG. 4 is an example of antimicrobial bacteriophage, or other agents and compounds used for targeted or personalized therapy or microbiome remodeling prediction model applied to two patients (#1 and #2) predicting their overall direction and impact on the microbial flora thus allowing for the optimization of treatment, minimizing the chance of infection recurrence and the impact on beneficial flora.

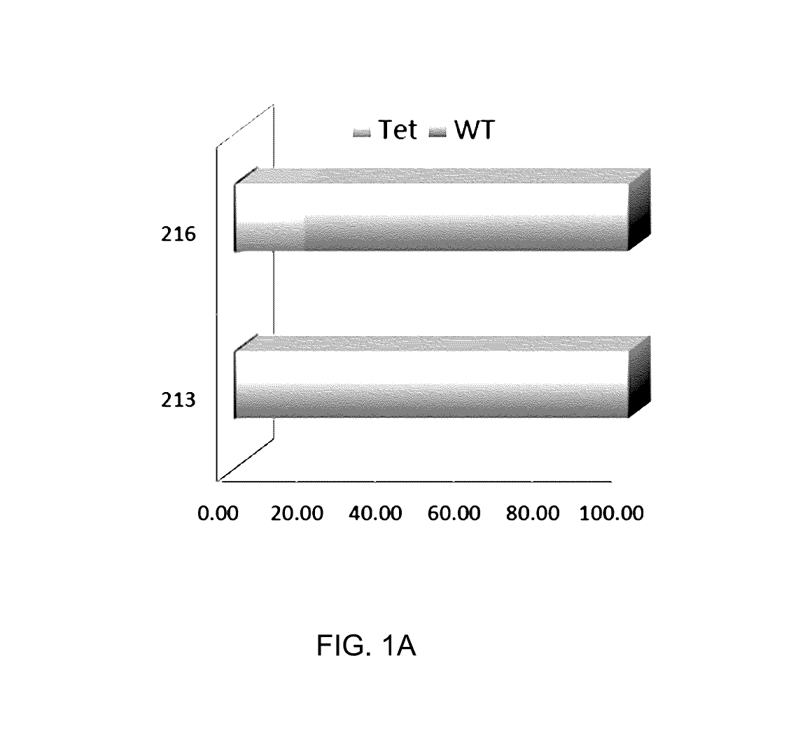

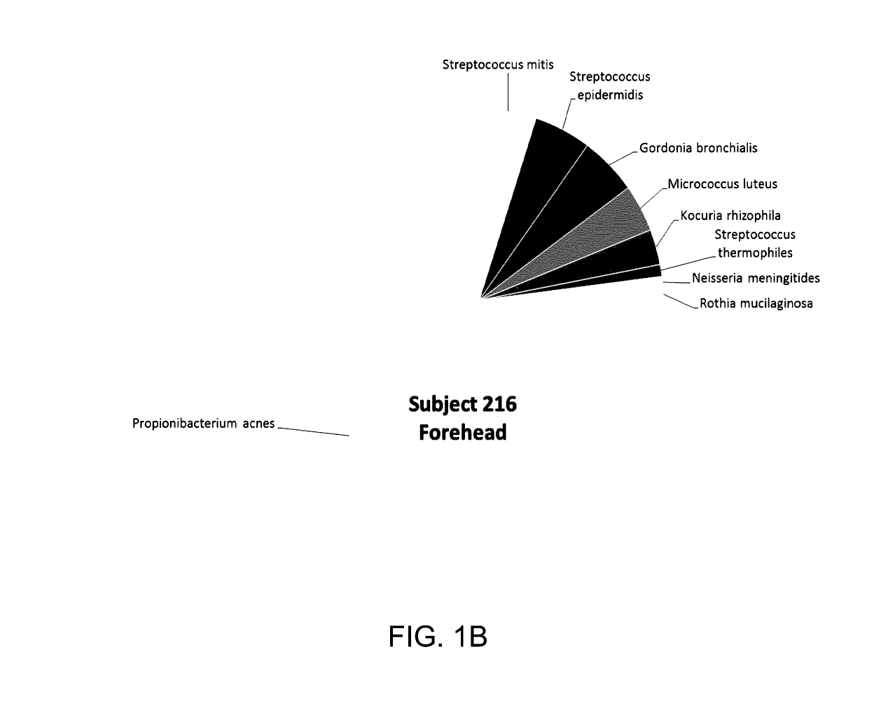

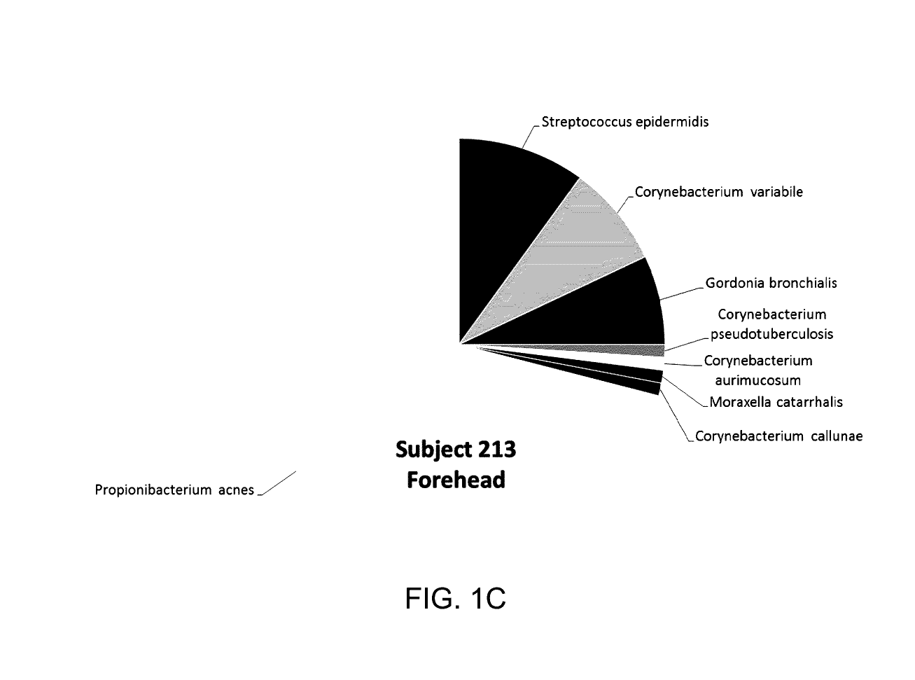

### SUMMARY OF THE INVENTION

The present invention relates to providing a platform for predictive modeling of changes in composition of microbial communities upon exposure to changes or perturbations in the environment, more specifically the introduction of antimicrobial compounds, bacteriophages, or other agents that can be used for targeted or personalized therapy or microbiome remodeling.

It applies a combination of phylogeny and genotyping for both identifying the phylogenetic information of the sample and also specifying which genes and functional elements are present in the sample. This information will be used for modeling and prediction of how different antimicrobial agents, bacteriophages, or other agents and compounds could impact the (homogeneous or heterogeneous) bacterial community residing within that sample. These agents can be used for targeted or personalized therapy or microbiome remodeling. This platform has applications for human and animal health as well as environmental purposes.

### DETAILED DESCRIPTION OF INVENTION

The present invention provides a platform using a combination of phylogeny and genotyping for modeling and prediction of how different antimicrobial agents, bacteriophages, or other agents and compounds that can be used for targeted or personalized therapy or microbiome remodeling could impact a (homogeneous or heterogeneous) bacterial community. However, we envision that any method that can simultaneously detect, characterize and quantify a plurality of bacteria could also be substituted for our approach.

The approach consists of the following modules:

A genomics platform can be used for both identifying the phylogenetic information of the sample and also specifying which genes and functional elements are present in the sample. All of the information can be used for accurate modeling of how the representative meta-genome will respond to one or more antibiotics, classes of antibiotics, bacteriophages, or agents and compounds that can be used for targeted or personalized therapy or microbiome remodeling.

As the first step, the phylogenetic information of the sample should be determined with a robust microbial profiling technique that allows reliable identification of complex bacterial species. Historically, identifying the complexity of microbial ecosystems has been very challenging, because many of the constituting microorganisms are not culturable. Genomics approaches, more specifically Next Generation Sequencing, or NGS, have been a powerful tool for rapid and accurate sequencing of cells or organisms, enabling dissection of the microbial composition of such complex ecosystems without relying on any intermediate culturing step. The phylogenetic information could be obtained by either a NGS-based whole genome sequencing approach, a 16S-based sequencing approach, or any alternative methodology like mass spectrometry that can be used for phylogenetic identification of bacterial species (FIG. 2, box I).

Presence or absence of antibiotic resistance genes, bacteriophage resistance profiles, genomic signatures that can cause resistance to agents and compounds that can be used for targeted or personalized therapy or microbiome remodeling or protein families can be identified using a molecular technique including but not limited to a proteomics, functional, or genomics-based approach. A whole genome sequencing approach can be used to achieve this. The target can be the presence or absence of a specific antibiotic resistance gene. Prominent examples are acetyl-transferases, nucleotidyl-transferases, or phosphotransferases for aminoglycoside resistance, β. lactamases for β. lactam antibiotics. ATP-binding transporters (ABC), major facilitator family transporters, esterases, hydrolases, transferases, and phosphorylases are examples of targets that indicate resistance to macrolides. VanA, VanB, VanC, VanD, VanE, and VanG operons involved in vancomycin resistance are other prominent examples. The targets could also be generic efflux pumps that can transfer antimicrobial compounds or other agents and compounds that can be used for targeted or personalized therapy or microbiome remodeling out of the cell, with examples like mexXY, acrAB, mtrCDE, Major Facilitator Superfamily (MFS) transporter, ATP-Binding Cassette transporter, Resistance-Nodulation-Cell Division (RND) transporter, and Small Multidrug Resistance (SMR) transporter. The target could also be a SNP (single nucleotide polymorphism) found in a drug target, for example SNPs that confer resistance to ciprofloxacin and doxycycline. Mutations in DNA gyrase or topoisomerase IV that confer resistance to quinolones are other notable examples. Alternatively, a comprehensive panel of resistant genes and elements for antimicrobial, bacteriophage, and other agents and compounds used for targeted or personalized therapy or microbiome remodeling (i.e. resistome) can be used to screen whether any of them are present in the desired microbial community. The target could be any of the previously characterized resistance genes including but not limited to any of the following genes: aac2ia, aac2ib, aac2ic, aac2id, aac2i, aac3ia, aac3iia, aac3iib, aac3iii, aac3iv, aac3ix, aac3vi, aac3viii, aac3vii, aac3x, aac6i, aac6ia, aac6ib, aac6ic, aac6ie, aac6if aac6ig, aac6iia, aac6iib, aad9, aad9ib, aadd, acra, acrb, adea, adeb, adec, amra, amrb, ant2ia, ant2ib, ant3ia, ant4iia, ant6ia, aph33ia, aph33ib, aph3ia, aph3ib, aph3ic, aph3iiia, aph3iva, aph3va, aph3vb, aph3via, aph3viia, aph4ib, aph6ia, aph6ib, aph6ic, aph6id, arna, baca, bcra, bcrc, bl1_acc, bl1_ampc, bl1_asba, bl1_ceps, bl1_cmy2, bl1_ec, bl1_fox, bl1_mox, bl1_och, bl1_pao, bl1_pse, bl1_sm, bl2a_1, bl2a_exo, bl2a_iii2, bl2a_iii, bl2a_kcc, bl2a_nps, bl2a_okp, bl2a_pc, bl2be_ctxm, bl2be_oxy1, bl2be_per, bl2be_shv2, bl2b_rob, bl2b_tem1, bl2b_tem2, bl2b_tem, bl2b_tle, bl2b_ula, bl2c_bro, bl2c_pse1, bl2c_pse3, bl2d_lcr_1, bl2d_moxa, bl2d_oxa10, bl2d_oxa1, bl2d_oxa2, bl2d_oxa5, bl2d_oxa9, bl2d_r39, bl2e_cbla, bl2e_cepa, bl2e_cfxa, bl2e_fpm, bl2e_y56, bl2f_nmca, bl2f sme1, bl2_ges, bl2_kpc, bl2_len, bl2_veb, bl3_ccra, bl3_cit, bl3_cpha, bl3_gim, bl3_imp, bl3_l, bl3_shw, bl3_sim, bl3_vim, ble, blt, bmr, cara, cata10, cata11, cata12, cata13, cata14, cata15, cata16, cata1, cata2, cata3, cata4, cata5, cata6, cata7, cata8, cata9, catb1, catb2, catb3, catb4, catb5, ceoa, ceob, cml_e1, cml_e2, cml_e3, cml_e4, cml_e5, cml_e6, cml_e7, cml_e8, dfra10, dfra12, dfra13, dfra14, dfra15, dfra16, dfra17, dfra19, dfra1, dfra20, dfra21, dfra22, dfra23, dfra24, dfra25, dfra25, dfra25, dfra26, dfra5, dfra7, dfrb1, dfrb2, dfrb3, dfrb6, emea, emrd, emre, erea, ereb, erma, ermb, ermc, ermd, erme, ermf, ermg, ermh, ermn, ermo, ermq, error, erms, ermt, ermu, ermv, ermw, ermx, ermy, fosa, fosb, fosc, fosx, fusb, fush, ksga, lmra, lmrb, lnua, lnub, lsa, maca, macb, mdte, mdtf mdtg, mdth, mdtk, mdtl, mdtm, mdtn, mdto, mdtp, meca, mecr1, mefa, mepa, mexa, mexb, mexc, mexd, mexe, mexf mexh, mexi, mexw, mexx, mexy, mfpa, mpha, mphb, mphc, msra, norm, oleb, opcm, opra, oprd, oprj, oprm, oprn, otra, otrb, pbp1a, pbp1b, pbp2b, pbp2, pbp2x, pmra, qac, qaca, qacb, qnra, qnrb, qnrs, rosa, rosb, smea, smeb, smec, smed, smee, smef srmb, sta, str, sul1, sul2, sul3, tcma, tcr3, tet30, tet31, tet32, tet33, tet34, tet36, tet37, tet38, tet39, tet40, teta, tetb, tetc, tetd, tete, tetg, teth, tetj, tetk, tetl, tetm, teto, tetpa, tetpb, tet, tetq, tets, tett, tetu, tety, tetw, tetx, tety, tetz, tlrc, tmrb, tolc, tsar, vana, vanb, vanc, vand, vane, vang, vanha, vanhb, vanhd, vanra, vanhb, vansc, vanhd, vanse, vansg, vansa, vansb, vansc, vansd, vanse, vansg, vant, vante, vantg, vanug, vanwb, vanwg, vanxa, vanhb, vanxd, vanxyc, vanxye, vanxyg, vanya, vanyb, vanyd, vanyg, vanz, vata, vatb, vatc, vatd, vate, vgaa, vgab, vgba, vgbb, vph, ykkc, or ykkd. Databases for antibiotic resistance genes and functions like Resfam and Antibiotic Resistance Database (ARDB) can be used to better characterize the comprehensive antimicrobial resistance landscape of each sample. However, resistance information is not always available (FIG. 2, box I versus II).

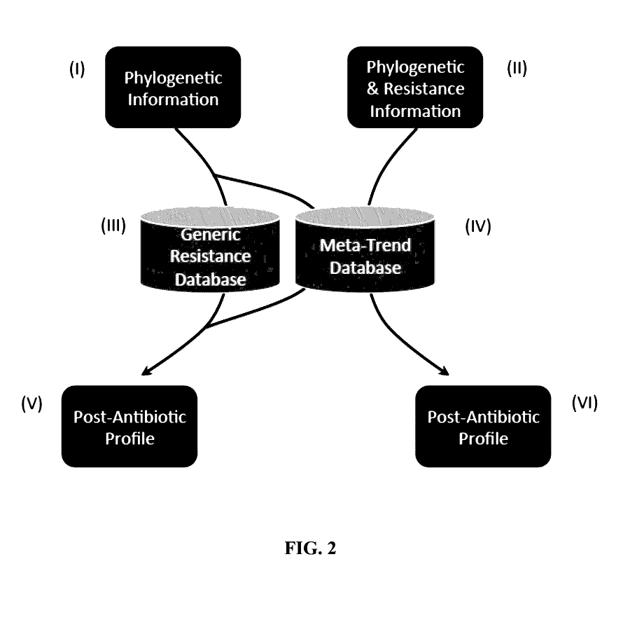

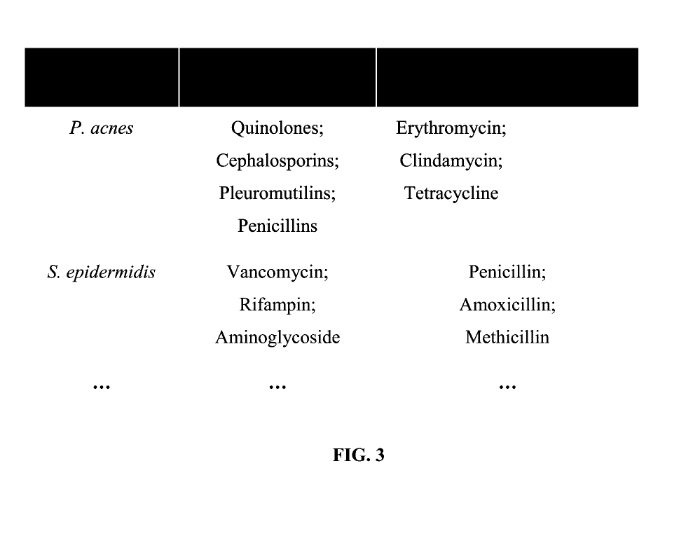

Existing knowledge about resistance elements for antimicrobial, bacteriophage, and other agents and compounds used for targeted or personalized therapy or microbiome remodeling (FIG. 2, box III and FIG. 3) can be leveraged, specifically for cases when there is no specific information available about the sample-specific resistance (or resistome) genes (FIG. 2, box I).

A database can be built from exposing complex or homogenous bacterial cultures with previously characterized composition to certain antimicrobial compounds, bacteriophage, and other agents and compounds used for targeted or personalized therapy or microbiome remodeling (FIG. 2, box IV). The composition of the sample should be determined after exposure and used to genotype or serotype the bacteria in any given microbiome of interest. As the next step, a collection of those microbes should be exposed individually to a panel of antibiotics, based on their survival, to make a database (i.e. matrix) of bacteria and their sensitivity to different antimicrobial compounds, bacteriophage, and other agents and compounds used for targeted or personalized therapy or microbiome remodeling.

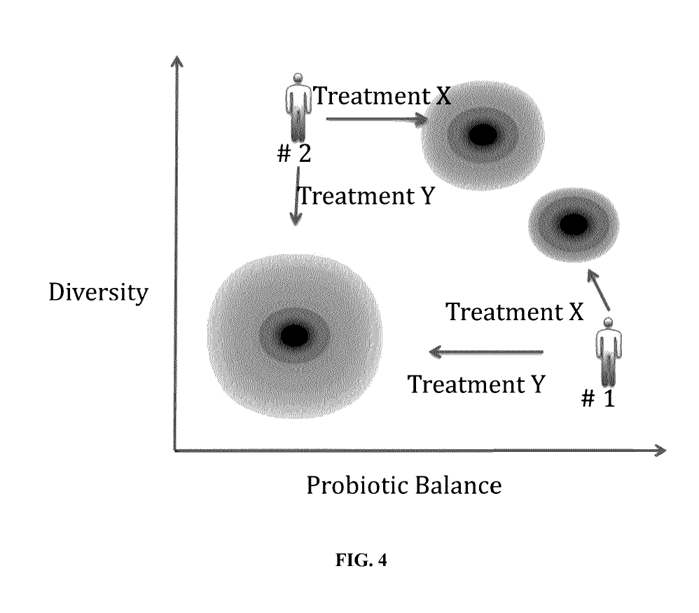

This matrix can be used to predict the response of any new microbiome to any antibiotic, bacteriophage, or other agents and compounds used for targeted or personalized therapy or microbiome remodeling that is part of the panel you used to build the database. A learning algorithm will be used to extrapolate the existing data points and infer how any new microbiome will respond to an antimicrobial, bacteriophage, or other agents and compounds used for targeted or personalized therapy or microbiome remodeling compound (FIG. 4). This algorithm will be able to provide direct evidence of a community's resistance profile against antimicrobial, bacteriophage, or other agents and compounds used for targeted or personalized therapy or microbiome remodeling.

The platform envisioned in this application has the ability to show how the use of a single or a plurality of agents or compounds would alter the microbial community. Agents or compound include, but are not limited to the following: synthetic or naturally derived antibiotics, disinfectants, antiseptics, preservatives, and competitive organisms (e.g. bacteriophages, commensal or mutualistic bacteria), other agents and compounds used for targeted or personalized therapy or microbiome remodeling or any other antimicrobial compound.

The platform envisioned in this application has the ability to predict lateral gene transfers/plasmid transfers that may impact the outcome of changes in the microbial environment.

### REFERENCES

1) Bleich R, Watrous J D, Dorrestein P C, Bowers A A, Shank E A. Thiopeptide antibiotics stimulate biofilm formation in Bacillus subtilis. PNAS. 2015, vol. 112 (10) 3086-3091, doi: 10.1073/pnas.

2) Gibson M K, Forsberg K J, Dantas G. Improved annotation of antibiotic resistance functions reveals microbial resistomes cluster by ecology. The ISME Journal. 2014, doi:ISMEJ.2014.106.

3) Liu B, Pop M. ARDB-Antibiotic Resistance Genes Database. Nucleic Acids Res. 2009 January; 37(Database issue):D443-7.

Although the invention has been described with reference to the above examples, it will be understood that modifications and variations are encompassed within the spirit and scope of the invention. Accordingly, the invention is limited only by the following claims.

What is claimed is:

1. A method to predict a therapeutic or remedial regimen for a defined physical environment, an aggregation of environments, or a patient, comprising modeling changes in the microbial environment before and after the administration of a antimicrobial agent.

2. A method to predict a therapeutic or remedial regimen for a defined physical environment, an aggregation of environments, or a patient, comprising modeling changes in the microbial environment before and after the administration of bacteriophage, or other agents and compounds.

3. The method of claim 1 or 2, wherein bacterial species are identified in the community.

4. The method of claim 1 or 2, wherein resistance or sensitivity elements are identified in the community.

5. A database comprising phylogeny, genotype, serotype, whole genome sequencing data obtained from modeling patients' microbial communities before and after administration of antimicrobial agents.

6. A database comprising phylogeny, genotype, serotype, whole genome sequencing data obtained from modeling patients' microbial communities before and after administration of bacteriophage, or other agents and compounds used for targeted or personalized therapy or microbiome remodeling.
